(19) United States
(12) Patent Application Publication
(10) Pub. No.: US 2007/0171495 A1
(43) Pub. Date: Jul. 26, 2007

(54) Hologram apparatus and recording method of the same

(76) Inventors: Kazuya Kogure, Gunma (JP); Kevin Curtis, Longmont, CO (US); Ken E. Anderson, Boulder, CO (US)

Correspondence Address: FISH & RICHARDSON P.C., P.O. BOX 1022, MINNEAPOLIS, MN, 55440-1022, US

(21) Appl. No.: 11/262,974

(22) Filed: Nov. 1, 2005

(30) Foreign Application Priority Data
Oct. 5, 2005 (JP) 2005-292370

(51) Int. Cl. G03H 1/00

(52) U.S. Cl. 359/30

(57) ABSTRACT

A hologram apparatus comprises a light detection unit detecting a light intensity of at least one of the data beam and the reference beam; a determination unit determining whether light intensities of the data beam and the reference beam reach to a reference value which can form a hologram having certain diffraction efficiency, based on the light intensity detected by the light detection unit; and a block unit blocking application of at least one of the data beam and the reference beam into the hologram recording medium, based on the result of the determination of the determination unit indicating that the light intensities of the data beam and the reference beam reach to the reference value.

### CROSS-REFERENCE TO RELATED APPLICATIONS

The present application claims priority from Japanese Patent Application No. 2005-292370 filed on Oct. 5, 2005, which is herein incorporated by reference.

### BACKGROUND OF THE INVENTION

1. Field of the Invention

The present invention relates to a hologram apparatus and a recording method of the hologram apparatus.

2. Description of the Related Art

Among hologram recording media adapted to record digital data as holograms is a photosensitive resin (e.g., photopolymer) sealed between glass substrates. To record digital data in a hologram recording medium as a hologram, a laser beam from a laser apparatus is first split into two beams by a PBS (Polarization Beam Splitter). Then, one of such laser beams (hereinafter referred to as “reference beam”) and a laser beam (hereinafter referred to as “data beam”), i.e., the beam reflecting two-dimensional gray image pattern information as a result of the irradiation of the other such beam into an SLM (Spatial Light Modulator) having digital data formed as a two-dimensional gray image pattern, are applied to a hologram recording medium at a given angle. This allows the recording of the digital data into the hologram recording medium.

More specifically, the photosensitive resin making up the hologram recording medium has a finite number of monomers. When the laser beam (hereinafter referred to as “laser beam”) made up of the reference and data beams is irradiated thereonto, the monomers change into polymers correspondingly with the energy determined by the light intensity of the laser beam and the irradiation time. As a result of the transformation of the monomers into polymers, an interference fringe, made up of polymers, is formed correspondingly with the laser beam energy. Therefore, as a result of the formation of such an interference fringe in the hologram recording medium, digital data is recorded as a hologram. Later, remaining monomers migrate (spread) to those locations that have consumed monomers. Further, as a result of the irradiation of the laser beam, such monomers change into polymers. It is to be noted that FIG. 2 schematically illustrates how monomers transform into polymers correspondingly with the laser beam energy in the hologram recording medium.

It is also to be noted that if a large amount of digital data must be recorded in the hologram recording medium, the incidence angle of the reference beam into the hologram recording medium is changed to enable the so-called “angle-multiplexed recording” adapted to form a number of holograms. For example, a hologram formed in the hologram recording medium is called a page, whereas a multiplexed hologram made up of a number of pages is called a book. FIG. 3 schematically illustrates the book and the pages in the angle-multiplexed recording. As shown in FIG. 3, the incidence angle of the reference beam is varied to form ten pages of holograms for a single book in the angle-multiplexed recording. Thus, the angle-multiplexed recording allows for the recording of a large amount of digital data.

To reproduce digital data from the volume hologram recording medium prepared by, what is called Bragg selectivity, on the other hand, the reference beam is applied to the interference fringe representing the digital data at the same incidence angle as when the interference fringe was formed. The reference beam (hereinafter referred to as “reproduction beam”) diffracted by the interference fringe is received by an image sensor or other means. The reproduction beam received by the image sensor or other means constitutes a two-dimensional gray image pattern representing the above-described digital data. Then, the digital data can be demodulated from this two-dimensional gray image pattern with a decoder or other means to reproduce the digital data.

In this way, since the digital data is reproduced from the hologram recording medium, in order to regenerate the two-dimensional gray image pattern using the reproduction beam, the reproduction beam must have a light intensity equal to or greater than certain level enabling an image sensor or the like to regenerate the two-dimensional gray image pattern. Therefore, in order to make the reproduction beam equal to or greater than certain level, the hologram diffracting the reference beam must have diffraction efficiency, which indicates a rate of a light intensity of the reproduction beam to a light intensity of the irradiated reference beam, equal to or greater than a predetermined value. The predetermined value of the diffraction efficiency is a value making a light intensity of the reproduction beam equal to the certain level.

By the way, the interference fringe formed in the hologram recording medium is formed by changing the monomers correspondingly with the laser beam energy to the polymers, as described. Since the monomers are in a finite number, when the interference fringe is not yet formed in the hologram recording medium, the monomers exist in the hologram recording medium in greatest number. Hereinafter, description is made for the case that, for example, two (2) pages of holograms are formed in the hologram recording medium by a laser beam with a constant energy value (i.e., an identical light intensity and a radiating time). When one (1) page of the hologram is formed in the hologram recording medium, monomers corresponding to the one (1) page are changed to polymers to form the interference fringe and, as a result, the monomers are reduced in the hologram recording medium. When a second page of the hologram is formed, the second page of the hologram has to be formed in the hologram recording medium with reduced monomers corresponding to a first page. However, if the second page of the hologram is formed by the laser beam with the constant energy value, since the monomers in the hologram recording medium are reduced, the above mentioned diffraction efficiency of the second page has to be a value lower than the diffraction efficiency of the first page. Therefore, when the reference beam is irradiated, a light intensity of the reproduction beam diffracted by the second-page interference fringe results in a level lower than that of the reproduction beam diffracted by the first-page interference fringe. FIG. 4 shows changes in the diffraction efficiency of each hologram formed in angle-multiplexed recording. As shown in FIG. 4, when the angle-multiplexed recording is performed with the laser beam with the constant energy value, as the pages increase, the monomers in the hologram recording medium is reduced and, as a result, increasingly lower value is generated as the diffraction efficiency of the interference fringe formed in the hologram recording medium. Further, the monomers in the hologram recording medium may be completely consumed and the interference fringe may not be formed, i.e., the digital data may possibly not be recorded.

Therefore, in order to form a large number of interference fringes having diffraction efficiency equal to or greater than the above described predetermined value to consume the monomers efficiently, in conventional art, a method has been used for controlling a time period radiating the laser beam from a laser apparatus. Specifically, table data is generated from laser beam irradiation time periods corresponding to each page in the angle-multiplexed recording and is recorded in advance in, for example, a memory provided in a system for recording and reproducing digital data as holograms (hereinafter, referred to as “hologram apparatus”). When, for example, a fourth page is recorded in the hologram recording medium, a irradiation time period corresponding to the fourth page is read out from the memory and, the irradiation time period of the laser beam is controlled by closing a shutter provided between the laser apparatus and the hologram recording medium at the time that a irradiation time period of the laser beam from the laser apparatus reaches the irradiation time period corresponding to the fourth page. See, e.g., Japanese Patent Application Laid-open Publications Nos. 05-27659, 2004-177958 and 2004-272268.

However, in a hologram apparatus controlling a irradiation time period of a laser beam to define an energy value, a laser apparatus provided in the hologram apparatus must have an identical property (e.g., a light intensity of the laser beam is constant, etc.). However, it has been technically difficult to produce laser apparatuses having an identical property. Therefore, for example, in one laser apparatus, a light intensity of the irradiated laser beam may be higher, whereas, in another laser apparatus, a light intensity of the irradiated laser beam may be smaller. So, if the irradiation time periods are controlled to be an identical time period, when formed by the laser apparatus with a higher light intensity in a hologram recoding medium, the diffraction efficiency of interference fringes can be a value smaller than diffraction efficiency for a predetermined value described above as the number of pages increases. Therefore, accurate holograms indicating digital data can increasingly not be formed in the hologram recording medium. Alternatively, in the laser apparatus with a smaller light intensity, if the irradiation periods are controlled to be an identical time period, interference fringes can not be formed with the diffraction efficiency for a predetermined value described above.

Especially, if semiconductor lasers are used as the laser apparatus, it is difficult to use the semiconductor lasers having an identical property as the laser apparatus because of variation of the light intensity due to individual properties and alteration of temperature thereof. If the semiconductor laser is used as the laser apparatus, a temperature of the semiconductor laser is measured by, for example, a thermistor. Then, in order to bring a temperature of the semiconductor laser measured by the thermistor to a desired temperature, the temperature must be adjusted by, for example, a heater; a light intensity of the laser beam irradiated from the semiconductor laser must be a light intensity corresponding to the desired temperature; and because the thermistor, the heater and others are needed, a system for recording and reproducing holograms can be complicated.

### SUMMARY OF THE INVENTION

It is therefore an object of the present invention to provide a hologram apparatus and a recording method for the hologram apparatus which can control a laser beam applied to a hologram recording medium depending on an energy value of the laser beam from a laser apparatus.

In order to achieve the above object, according to an aspect of the present invention there is provided a hologram apparatus applying a coherent data beam corresponding to data to be recorded and a coherent reference beam to a hologram recording medium to record the data in the form of a hologram in the hologram recording medium, the hologram apparatus comprising a light detection unit detecting a light intensity of at least one of the data beam and the reference beam; a determination unit determining whether light intensities of the data beam and the reference beam reach to a reference value which can form a hologram having certain diffraction efficiency, based on the light intensity detected by the light detection unit; and a block unit blocking application of at least one of the data beam and the reference beam into the hologram recording medium, based on the result of the determination of the determination unit indicating that the light intensities of the data beam and the reference beam reach to the reference value.

In order to achieve the above object, according to another aspect of the present invention there is provided a recording method for a hologram apparatus configured to apply a coherent data beam corresponding to data to be recorded and a coherent reference beam to a hologram recording medium to record the data in the form of a hologram in the hologram recording medium, the recording method comprising detecting a light intensity of at least one of the data beam and the reference beam; determining whether light intensities of the data beam and the reference beam reach to a reference value which can form a hologram having certain diffraction efficiency, based on the detected light intensity; and blocking application of at least one of the data beam and the reference beam into the hologram recording medium when the light intensities of the data beam and the reference beam reach to the reference value.

The present invention can provide the hologram apparatus and the recording method for the hologram apparatus, capable of controlling laser beams applied to the hologram recording medium depending on the energy value of the laser beam from the laser apparatus.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 shows an example of an entire configuration of a hologram apparatus according to the present invention;

FIG. 2 is a diagram schematizing how monomers transform into polymers correspondingly with the laser beam energy;

FIG. 3 is a diagram schematically illustrating a book and pages in angle-multiplexed recording;

FIG. 4 shows changes in diffraction efficiency of each hologram formed in angle-multiplexed recording;

FIG. 5 shows diffraction efficiencies of each hologram formed in angle-multiplexed recording;

FIG. 6 shows a graphic representation of multiplication results in DSP 37 of FIG. 1;

FIG. 7 is a timing chart showing an example of operations of the hologram apparatus according to the present invention;

FIG. 8 is a flowchart showing an example of operations of the DSP 37 constituting the hologram apparatus according to the present invention;

FIG. 9 shows an example of an entire configuration of the hologram apparatus according to the present invention; and

FIG. 10 is a timing chart showing an example of operations of the hologram apparatus according to the present invention.

### DETAILED DESCRIPTION OF THE INVENTION

At least following items will become apparent from this specification and drawings annexed thereto.

### FIRST IMPLEMENTATION

21 Overall Configuration of Hologram Apparatus>

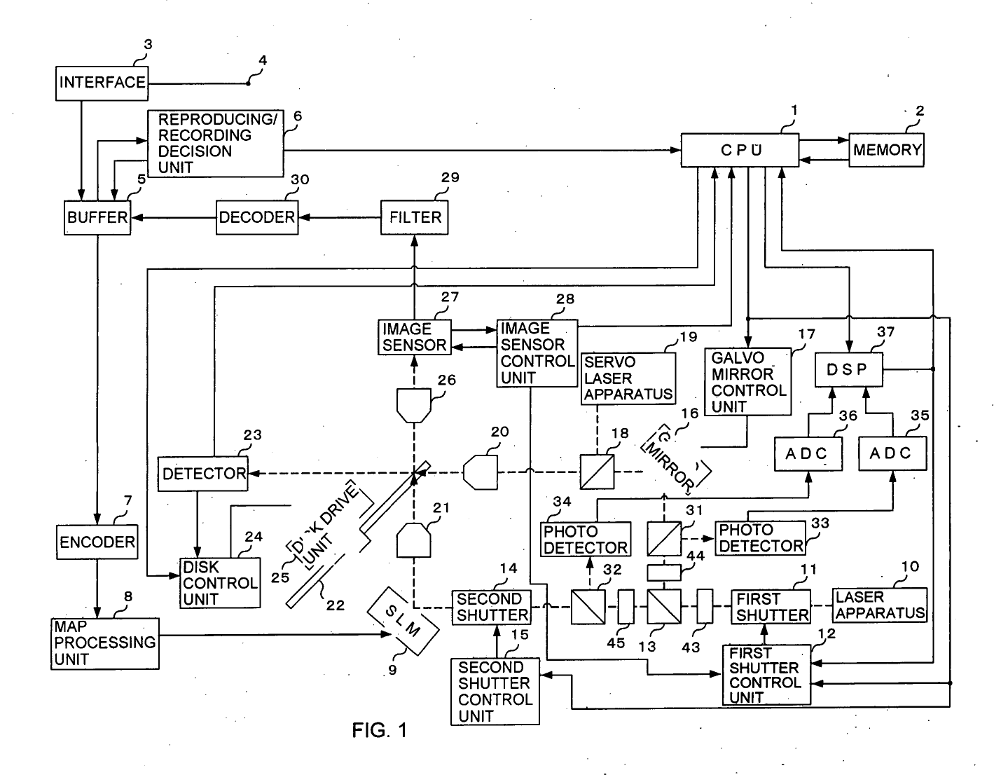

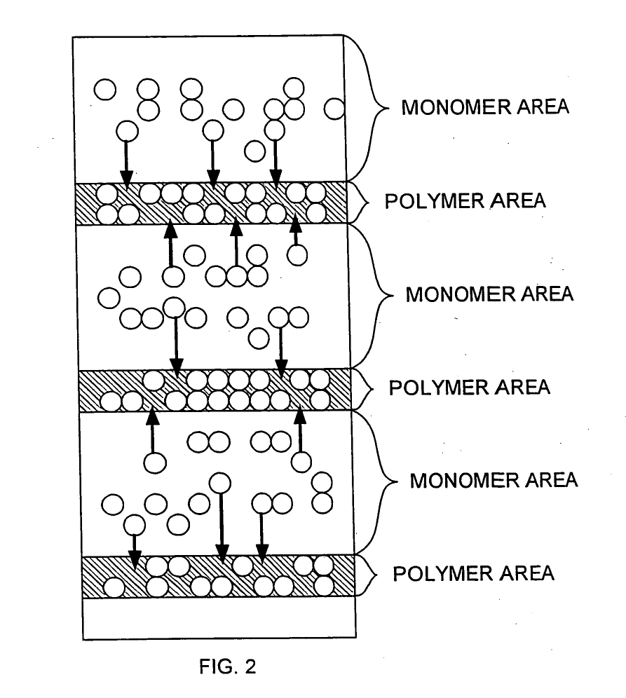

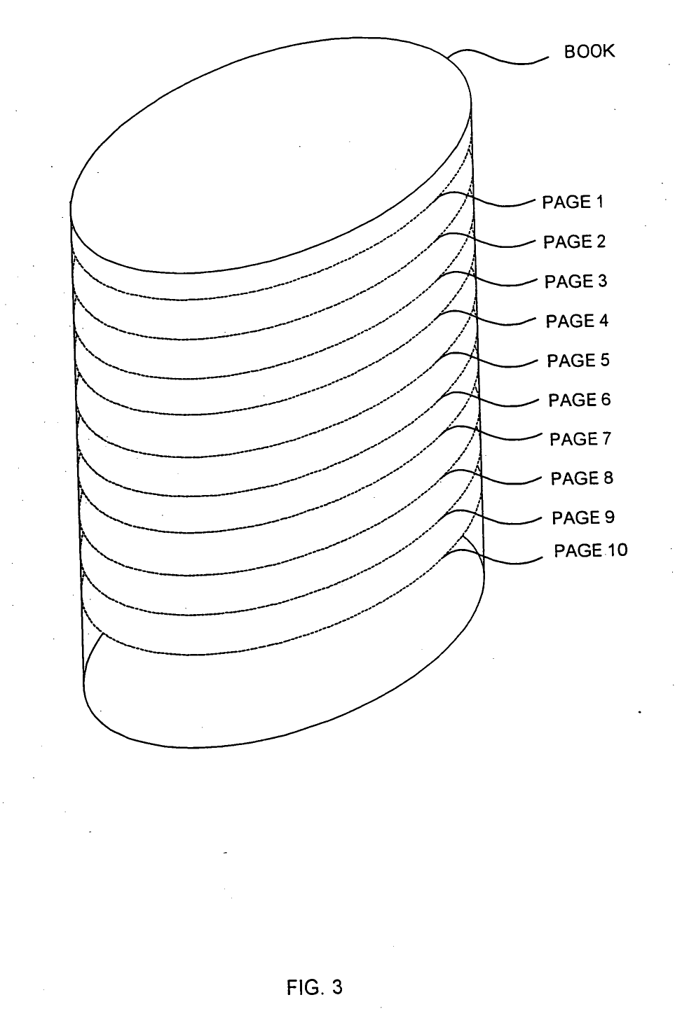

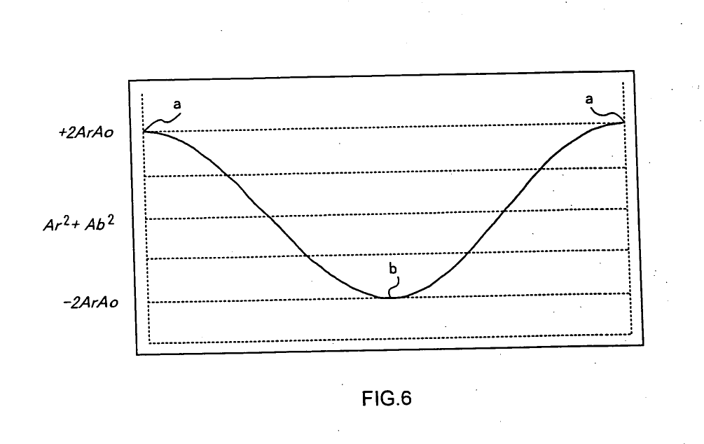

Referring to FIG. 1, FIG. 5 and FIG. 6, a hologram apparatus according to the present invention is described. FIG. 1 is a functional block diagram showing an example of an entire configuration of the hologram apparatus according to the present invention. FIG. 5 shows diffraction efficiencies of each hologram formed in angle-multiplexed recording. FIG. 6 shows a graphic representation of multiplication results in DSP 37 of FIG. 1.

The hologram apparatus has a CPU (Central Processing Unit) 1 (page number calculation unit), a memory 2, an interface 3, a connection terminal 4, a buffer 5, a reproducing/recording determination unit 6, an encoder 7, a map processing unit 8, an SLM 9, a laser apparatus 10, a first shutter 11 (blocking unit), a first shutter control unit 12, PBS 13, 31 (reference beam split unit) and 32 (data beam split unit), a second shutter 14, a second shutter control unit 15, a galvo mirror 16 (deflection unit), a galvo mirror control unit 17 (deflection control unit), a dichroic mirror 18, a servo laser apparatus 19, a scanner lens 20, Fourier transform lenses 21 and 26, a detector 23, a disc control unit 24, a disc drive unit 25, an image sensor 27, an image sensor control unit 28, a filter 29, a decoder 30, ½ wavelength plates 43, 44 and 45, photo detectors 33 ((a second) light detector) and 34 ((a first) light detector), ADC (Analog Digital Converters) 35 and 36, a DSP (Digital Signal Processor) 37 (determination unit/light intensity calculation unit).

The interface 3 intervenes for host equipment (not shown) such as PC (Personal Computer) connected via the connection terminal 4 and the hologram apparatus performing transmission/reception of data.

The buffer 5 stores reproduction instruction data from the host equipment for reproducing data stored in a hologram recording medium (medium for recording holograms) 22. Also, the buffer 5 stores record instruction data for recording data from the host equipment in the hologram recording medium 22. Further, the buffer 5 stores data recorded in the hologram recording medium 22.

The reproducing/recording determination unit 6 determines whether the reproduction instruction data or the record instruction data are recorded in the buffer 5 or not in predetermined timing. If determining that the reproduction instruction data is stored in the buffer 5, the reproducing/recording determination unit 6 sends to CPU 1 an instruction signal for executing reproduction processing in the hologram apparatus. If determining that the record instruction data is stored in the buffer 5, the reproducing/recording determination unit 6 sends to CPU 1 an instruction signal for executing record processing in the hologram apparatus, and data to be stored in the hologram recording medium 22 is sent from the host equipment to the encoder 7. Further, the reproducing/recording determination unit 6 sends to CPU 1 information about an amount of data to be stored in the hologram recording medium 22.

The encoder performs encode processing for the data from the buffer 5.

The map processing unit 8 rearranges the data from the encoder 7 to a two-dimensional data array (e.g., 1280 bits of height×1280 bits of width≈1.6 megabits) to form unit-page array data.

The SLM 9 forms a two-dimensional gray image pattern based on the unit-page array data formed in the map processing unit 8. The two-dimensional gray image pattern is formed by, for example, allocating “brightness” to one logical value of the data constituting the unit-page array data and “darkness” to the other logical value. For example, if the SLM can form a two-dimensional gray image with 1280 pixels of height×1280 pixels of width, the two-dimensional gray image is formed from 1.6 megabits data from the map processing unit 8 by allocating brightness or darkness to one (1) pixel per one (1) bit of data. As described below, when irradiated by a second laser beam from the laser apparatus 10, the SLM 9 reflects the second laser beam to the Fourier transform lens 21. Then, the reflected second laser beam will be a laser beam reflecting information of the two-dimensional gray image pattern formed in the SLM 9 (hereinafter, referred to as a “data beam”). As shown in FIG. 1, this is not limited to the case that the SLM 9 is linearly irradiated by the second laser beam from the PBS 13. For example, this may be the case that PBS (not shown) is provided on the light path between the second shutter 14 and the SLIM 9 and a split laser beam is radiated from the PBS to the SLM 9.

The laser apparatus 10 irradiates laser beams with excellent temporal coherence and spatial coherence to the first shutter 11. As the laser apparatus 10, for example, a helium-neon laser, an argon-neon laser, a helium-cadmium laser, a semiconductor laser (an external resonance laser diode), a dye laser, a ruby laser and the like are used in order to form holograms in the hologram recording medium 22.

The CPU 1 controls the hologram apparatus generally. When receiving an instruction signal based on the record instruction data from the reproducing/recording determination unit 6, the CPU 1 reads out address information based on pits already formed in the hologram recording medium 22. Then, the CPU 1 sends to the disc control unit 24 an instruction signal for rotating the hologram recording medium 22 in order to irradiate a laser beam from the servo laser apparatus 19 (hereinafter, referred to as a “servo laser beam”) to a pit provided in the hologram recording medium 22 indicating next address information.

Also, in order to make the galvo mirror control unit 17 perform angle adjustment of the galvo mirror 16, the CPU 1 sends an instruction signal to the galvo mirror control unit 17.

Further, the CPU 1 calculates the number of holograms (i.e., the number of pages) formed in the hologram recording medium 22, based on information of a data amount from the reproducing/recording determination unit 6. Also, the CPU 1 sends a trigger signal to the DSP 37 in order to open the first shutter 11 as well as an instruction signal for opening the second shutter 14 to the second shutter control unit 15. As a result, holograms are started to be recorded in the hologram recording medium 22. For example, since, if the information of a data amount from the reproducing/recording determination unit 6 is four (4) megabits, the SLM 9 can process the above described about 1.6 megabits data into a two-dimensional gray image pattern, the CPU 1 calculates the number of holograms corresponding to at least three (3) pages from a data amount of four (4) megabits. Then the CPU 1 sequentially reads out optimum laser beam energy values (hereinafter, referred to as “reference energy values”) corresponding to each page formed in the hologram recording medium 22, which are stored in the memory 2 as described below. The CPU 1 sends the reference energy value to the DSP 37. The CPU 1 receives the instruction signal for closing the first shutter 11 from the DSP 37. In other words, firstly, the CPU 1 calculates the number of holograms (e.g., three (3) pages) from the information of a data amount and then reads out a reference energy value corresponding to a first page from the memory 2. Subsequently, the CPU 1 receives the instruction signal for closing the first shutter 11 from the DSP 37 and then reads out a reference energy value corresponding to a second page from the memory 2. Further, the CPU 1 receives the instruction signal for closing the first shutter 11 from the DSP 37 and then reads out a reference energy value corresponding to a third page from the memory 2. Then, the CPU 1 receives the instruction signal for closing the first shutter 11 from the DSP 37 and then sends the instruction signal for closing the second shutter 14 to the second shutter control unit 15. As a result, the hologram recording is terminated in the hologram recording medium 22.

Further, the CPU 1 receives the instruction signal based on the reproduction instruction data from the reproducing/recording determination unit 6 and then sends to the disc control unit 24 an instruction signal for rotating the hologram recording medium 22 in order to irradiate the servo laser beam from the servo laser apparatus 19 to a pit formed in the hologram recording medium 22 indicating the address information corresponding to the reproduction instruction data. Further, the CPU 1 receives the instruction signal based on the reproduction instruction data and then sends the instruction signal for opening the first shutter 11 to the first shutter control unit 12 as well as sends the instruction signal for opening the second shutter 14 to the second shutter control unit 15. Also, in order to make the galvo mirror control unit 17 perform angle adjustment of the galvo mirror 16, the CPU 1 sends the instruction signal to the galvo mirror control unit 17. As a result, holograms are started to be reproduced from the hologram recording medium 22. Subsequently, if the CPU 1 determines that a predetermined time has elapsed for the reproduction processing based on the reproduction instruction data, the CPU 1 sends the instruction signal for closing the first shutter 11 to the first shutter control unit 12. As a result, the reproduction of holograms from the hologram recording medium 22 is terminated. The CPU 1 may terminate the reproduction processing due to a signal based on a result of a determination from the image sensor control unit 28 described below.

The first shutter control unit 12 performs control for opening or closing the first shutter 11 based on the instruction signals from the CPU 1. Also, the first shutter control unit 12 performs control for closing the first shutter 11 based on an instruction signal from the image sensor control unit 28. Further, the first shutter control unit 12 performs control for opening or closing the first shutter 11 based on the instruction signals from the DSP 37. When opening the first shutter 11, the first shutter control unit 12 sends an open-state instruction signal to the first shutter 11. Also, when closing the first shutter 11, the first shutter control unit 12 sends a closed-state instruction signal to the first shutter 11.

The first shutter 11 enters into an open state based on the open-state instruction signal from the first shutter control unit 12. Alternatively, the first shutter 11 enters into a closed state based on the closed-state instruction signal from the first shutter control unit 12. When the first shutter 11 is in the closed state, irradiation of the laser beam from the laser apparatus 10 to the ½ wavelength plate 43 is blocked.

The ½ wavelength plate 43 is provided at a predetermined tilt in order to determine an angle at which the laser beam is irradiated from the laser apparatus 10 to the PBS 13 when the first shutter is in the open state. The predetermined tilt of the ½ wavelength plate 43 is determined such that a split rate will be a desired rate when the laser beam is split into two (2) laser beams by the PBS 13.

The PBS 13 splits the laser beam from the ½ wavelength plate 43 into two (2) laser beams. One of laser beams split by the PBS 13 is applied to the PBS 32. The other laser beam (hereinafter, referred to as a “reference beam”) is applied to the PBS 31.

The ½ wavelength plate 44 is provided at a predetermined tilt in order to determine an angle at which the reference beam is irradiated from the PBS 13 to the PBS 31. The predetermined tilt of the ½ wavelength plate 44 is determined such that a split rate will be a desired rate when the reference beam is split into two (2) reference beams by the PBS 31.

The PBS 31 splits the reference beam from the ½ wavelength plate 44 into two (2) reference beams. One reference beam split by the PBS 31 (hereinafter, referred to as a “first reference beam”) is applied to the photo detector 33. The other reference beam (hereinafter, referred to as a “second reference beam”) is applied to the galvo mirror 16.

The photo detector 33 sends to the ADC 35 an analog electric signal corresponding to a light intensity of the first reference beam from the PBS 31.

The ADC 35 converts the analog electric signal from the photo detector 33 into digital data corresponding to the analog electric signal and sends the digital data to the DSP 37.

The galvo mirror 16 reflects the second reference beam from the PBS 13 to the dichroic mirror 18.

The galvo mirror control unit 17 controls an angle of the galvo mirror 16, in order to adjust an angle at which the second reference beam reflected by the galvo mirror is applied to the hologram recording medium 22 via the dichroic mirror 18 and the scanner lens 20, based on the instruction signal from the CPU 1. At the time of recording in the hologram recording medium 22, this angle adjustment of the galvo mirror 16 with the galvo mirror control unit 17 is performed in order to record the information of the two-dimensional image pattern in the hologram recording medium 22 as a hologram.

Specifically, because the data beam and the second reference beam are subjected to interference within the hologram recording medium 22, three-dimensional interference fringes (holograms) are formed. In other words, by holograms being formed in the hologram recording medium, the information of the two-dimensional pattern is recorded. Also, by adjusting the angle of the galvo mirror 16, i.e., by changing the incident angle of the second reference beam to the hologram recording medium 22, the galvo mirror control unit 17 enables the angle-multiplexed recording. Hereinafter, one (1) hologram formed in the hologram recording medium 22 is referred to as a page, and a multiplex recorded hologram formed from multiple overlapped pages in the angle-multiplexed recording is referred to as a book.

At the time of reproduction from the hologram recording medium 22, the galvo mirror control unit 17 controls an angle of the galvo mirror 16, in order to irradiate the second reference beam to the hologram formed in the hologram recording medium 22. At the time of reproduction, this angle adjustment of the galvo mirror 16 with the galvo mirror control unit 17 is performed in order to irradiate the second reference beam to the hologram, which is formed based on data to be reproduced, at the angle of the second reference beam when the hologram was formed from the data to be reproduced.

The servo laser apparatus 19 irradiates the servo laser beam to the dichroic mirror 18 in order to detect a location of the hologram formed in the hologram recording medium 22, based on address information indicated by the pits, by illuminating the pits provided in the hologram recording medium 22. The servo laser beam irradiated from the servo laser apparatus 19 is a beam with a predetermined wavelength which has no impact on the holograms formed in the hologram recording medium 22. In the implementation, a blue laser beam used as the laser beam irradiated from the laser apparatus 10 and a red laser beam with a wavelength longer than the blue laser beam is used as the servo laser beam.

The irradiation of the servo laser beam from the servo laser apparatus 19 is, for example, started as the hologram apparatus is started up and the servo laser beam is continuously irradiated while the hologram apparatus is activated. However, although the servo laser beam is considered to be continuously irradiated, the present invention is not limited to this. For example, while the hologram apparatus is recording data into the hologram recording medium 22, the hologram recording medium 22 is in a stopped state. Therefore, during a period when the servo laser beam is not necessarily needed to be applied to the pits, the servo laser beam may be stopped being irradiated from the servo laser apparatus. As a result, a load of the servo laser beam can be reduced in the servo laser apparatus 19.

The dichroic mirror 18 transmits the second reference beam reflected by the galvo mirror 16 and irradiates the second reference beam to the scanner lens 20. Also, the dichroic mirror 18 reflects the servo laser beam irradiated from the servo laser apparatus 19 and irradiates the servo laser beam to the scanner lens 20.

The scanner lens 20 deflects the second reference beam from the dichroic mirror 18 in order to ensure that the second reference beam is applied to the hologram recording medium 22. Also, the scanner lens 20 irradiates the servo laser beam from the servo laser apparatus 19 reflected by the dichroic mirror 18 into the hologram recording medium 22.

The ½ wavelength plate 45 is provided at a predetermined tilt in order to determine an angle at which one of laser beams from the PSB 13 is applied to the PBS 32. The predetermined tilt of the ½ wavelength plate 45 is determined such that a split rate will be a desired rate when the one of laser beams is split into two (2) laser beams by the PBS 32.

The PBS 32 splits the one of laser beams from the ½ wavelength plate 45 into two (2) laser beams. One of laser beams split by the PBS 32 (hereinafter, referred to as a “first laser beam”) is applied to the photo detector 34. The other laser beam (hereinafter, referred to as a “second laser beam”) is applied to the second shutter 14.

The photo detector 34 sends to the ADC 36 an analog electric signal corresponding to a light intensity of the first laser beam from the PBS 32.

The ADC 36 converts the analog electric signal from the photo detector 34 into digital data corresponding to the analog electric signal and sends the digital data to the DSP 37. In the implementation, the same bit resolution is used as a bit resolution when the analog electric signal from the photo detector 34 is converted into the digital data by the ADC 36 and as a bit resolution when the analog electric signal from the photo detector 33 is converted into the digital data by the ADC 35 described above.

The second shutter control unit 15 performs control for opening or closing the second shutter 14 based on the instruction signals from the CPU 1. When opening the second shutter 14, the second shutter control unit 15 sends an open-state instruction signal to the second shutter 14. Also, when closing the second shutter 14, the second shutter control unit 15 sends a closed-state instruction signal to the second shutter 14. In the implementation, although the second shutter control unit 15 is provided in order to perform the control for opening or closing the second shutter 14 based on the instruction signals from the CPU 1, the present invention is not limited to this. For example, the second shutter control unit 15 may be provided such that the control is performed in order to open or close the second shutter 14 based on the instruction signal from the DSP 37 which has received the trigger signal from the CPU 1 as described above.

The second shutter 14 enters into an open state based on the open-state instruction signal from the second shutter control unit 15. Alternatively, the second shutter 14 enters into a closed state based on the closed-state instruction signal from the second shutter control unit 15. When the second shutter 14 is in the closed state, irradiation of the second laser beam split by the PBS 32 to the SLM 9 is blocked. The second shutter 14 may be provided on a light path of the data beam irradiated from the SLM 9 into the hologram recording medium 22 via the Fourier transform lens 21.

While the Fourier transform lens 21 focuses the data beam reflecting the information of the two-dimensional gray image pattern described above from the SLM 9, the data beam is subjected to the Fourier transform and applied to the hologram recording medium 22.

The hologram recording medium 22 is constructed by using a photosensitive resins which can record data as holograms (e.g., photopolymer, silver salt emulsion, bichromated gelatin, photoresists and the like) and by sealing the light-sensitive resin between glass substrates. In the hologram recording medium 22, holograms are formed from the Fourier-transformed data beam indicating the two-dimensional gray image pattern from the Fourier transform lens 21 and the interference with the second reference beam from the scanner lens 20. In the hologram recording medium 22, the finite number of monomers exists and the monomers are reacted with the laser beam (made up of the data beam and the second reference beam) applied to the hologram recording medium 22 to form the polymers, resulting in the holograms. As the energy value of the laser beam becomes greater, more monomers react and become polymers to form a hologram with high diffraction efficiency of the second reference beam. As described above, by adjusting the angle of the galvo mirror 16 with the galvo mirror control unit 17 and by forming a hologram again from the interference of the data beam and the second reference beam from the galvo mirror 16 after the angle adjustment, the angle-multiplexed recording is performed to form the book in the hologram recording medium 22.

On the glass substrates constituting the hologram recording medium 22, for example, wobbles are formed in advance, and address information is formed in the wobbles as pits in advance for defining locations of holograms formed in the hologram recording medium 22. The pits indicating the address information are illuminated by the servo laser beam from the servo laser apparatus 19, which is irradiated from the scanner lens 20. After illuminating the bits indicating the address information, the servo laser beam is applied to the detector 23.

At the time of reproduction of the holograms, when the second reference beam is applied to the hologram recording medium 22, a beam diffracted by the recorded holograms in the hologram recording medium (hereinafter, referred to as a “reproduction beam”) is applied to the Fourier transform lens 26. An incident angle of the second reference beam at the time of reproduction of the holograms is required to be identical to an incident angle of the second reference beam at the time of recording of the holograms to be reproduced. The Fourier transform lens 26 irradiates the inverse Fourier-transformed reproduction beam to the image sensor 27.

The image sensor 27 is illuminated by the inverse Fourier-transformed reproduction beam from the Fourier transform lens 26. The image sensor 27 consists of, for example, CCD (Charge Coupled Devices) or CMOS (Complementary Metal Oxide Semiconductor) image sensor, and regenerates the two-dimensional gray image patterns from the reproduction beams. The image sensor 27 converts brightness and darkness of each two-dimensional gray image pattern into high and low intensity of an electric signal and sends to the filter 29 an analog signal having a level corresponding to a light intensity of brightness and darkness of each two-dimensional gray image pattern. In the implementation, when the image sensor control unit 28 has determined that the image sensor 27 is illuminated by the reproduction beam with a light intensity equal to or greater than a predetermined light intensity, the image sensor control unit 28 sends to the first shutter control unit 12 an instruction signal for closing the first shutter 11. Also, both the SLM 9 and the image sensor 27 can form the same two-dimensional gray image pattern with 1280 pixel×1280 pixel. However, although both the SLM 9 and the image sensor 27 are arranged for the same number of pixels, the present invention is not limited to this. For example, the number of pixels of the image sensor 27 may be arranged to be greater than the number of pixels of the SLM 9. By arranging the number of pixels of the image sensor 27 greater than the number of pixels of the SLM 9, the reproduction beam from the Fourier transform lens 26 is ensured to be applied to the image sensor 27, and the regeneration of the two-dimensional gray image pattern can be certainly executed. Also, when the image sensor control unit 28 performs processing for shifting the image sensor to a predetermined location, required accuracy can be reduced.

The filter 29 filters the analog electric signal based on a light intensity of brightness and darkness of the two-dimensional gray image pattern regenerated by the image sensor 27, in order to enhance dissolubility of binarization processing. For example, in the two-dimensional gray image pattern regenerated by the image sensor 27, clear brightness and darkness may not be regenerated in comparison with brightness and darkness of the two-dimensional gray image pattern formed by the SLM, due to noises and the like affecting the data beam, the reproduction beam and the like. Therefore, for a level of the analog electric signal based on brightness and darkness of the two-dimensional gray image pattern regenerated by the image sensor 27, it may not be clear whether the level is in a level indicating “brightness” or in a level indicating “darkness”, and the binarization processing may not be performed properly. Therefore, by filtering with the filter 29, the level of the analog electric signal is corrected. In the implementation, a binarization processing unit (not shown) is provided between the filter 29 and the decoder 30 to perform the binarization processing for the analog electric signal from the filter 29. In the following description, it is assumed that digital signal obtained as a result of the binarization processing is sent to the decoder 30.

The decoder 30 performs decode processing for the digital signal from the binarization processing unit.

The memory 2 stores program data in advance for the CPU1 performing the processing described above. For each page constituting the book in the angle-multiplexed recording, the memory 2 stores optimum reference energy values of the laser beam made up of the data beam and the second reference beam in advance, which are obtained from experiments and the like, corresponding to the each page. The reference energy values are determined based on results of experiments and the like, in order to form numerous interference fringes having diffraction efficiency of a predetermined value X shown in FIG. 5 in the hologram recording medium 22 using energy values of the laser beam made up of the data beam and the second reference beam corresponding to each page in the angle-multiplexed recording. This predetermined value X for diffraction efficiency can be determined depending on a light intensity of the reproduction beam with which the image sensor 27 can regenerate the two-dimensional gray image pattern based on the reproduction beam described above. Also, the reference energy value indicates greater value as more pages are formed in the hologram recording medium 22 and enables the hologram recording medium 22 to be provided with numerous interference fringes having diffraction efficiency of a predetermined value X (see FIG. 5). Also, the memory 2 stores the address information from the pits formed in the hologram recording medium 22 from the CPU 1 described above. The memory 2 consists of nonvolatile memory elements for enabling data to be written and read repeatedly by electrically erasing data.

When receiving the trigger signal from the CPU 1, the DSP 37 sends to the first shutter control unit 12 the instruction signal for opening the first shutter 11 as well as resets calculation processing of an energy value P described below. To the DSP 37, the digital data corresponding to a light intensity of the first reference beam is sent from the ADC 35. Also, to the DSP 37, the digital data corresponding to a light intensity of the first laser beam is sent from the ADC 36. Based on the digital data from the ADC 35 and the digital data from the ADC 36, the DSP 37 can calculate an energy value of the laser beam made up of the data beam and the second reference beam illuminating the hologram recording medium 22 at this time (i.e., an energy value forming a hologram (page)). This is because the data beam (i.e., the second laser beam) and the first laser beam have been split in the PBS 32, and the first reference beam and the second reference beam have been split in the PBS 31. Therefore, it is believed that an energy value of the first laser beam reflects that of the data beam and that an energy value of the first reference beam reflects that of the second reference beam. Consequently, it is believed that the energy value of the laser beam made up of the data beam and the second reference beam illuminating the hologram recording medium 22 reflects that of the laser beam made up of the first laser beam and the first reference beam. And, by calculating the energy value P of the laser beam made up of the first laser beam and the first reference beam in the DSP 37, the calculation can be performed for the energy value made up of the data beam and the second reference beam illuminating the hologram recording medium 22. The energy value P of the laser beam made up of the first laser beam and the first reference beam can be found by multiplying the energy value of the first laser beam and the energy value of the first reference beam and by performing integration of the multiplication result with time t. The time t is a time period while the photo detector 33 is illuminated by the first reference beam or a time period while the photo detector 34 is illuminated by the first laser beam, and both time periods are the same.
Er=Ar·exp(−jωt+φr) Eq. 1
Eo=Ao·exp(−jωt+φo) Eq. 2
where
Ar is amplitude of the first reference beam;
jωt is an angular velocity;
φr is a phase difference of the first reference beam;
Ao is amplitude of the first laser beam; and
φo is a phase difference of the first laser beam;
   I(t)=|Er+Eo|² Eq. 3
   i(t)=Ar²+Ao²+2·Ar·Ao·cos (φr−φo) Eq. 4
   P=∫Ar·AoΔt Eq. 5

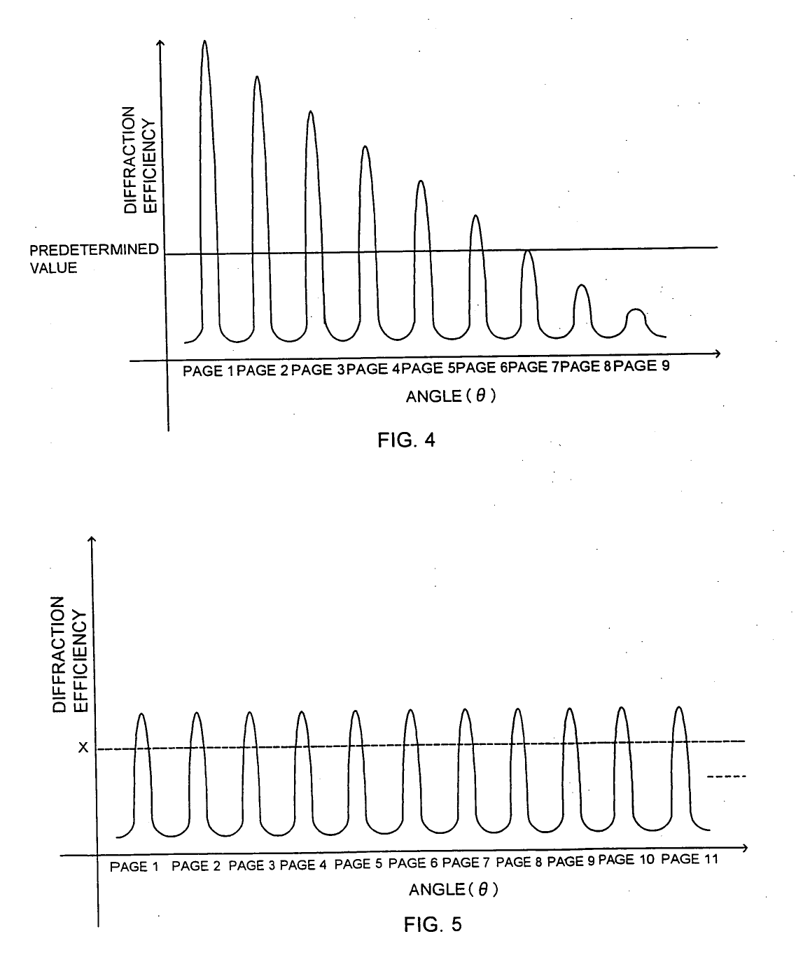

For example, an absolute value of the equation 1 can represent the energy value Er of the first reference beam indicated by the digital data from the ADC 35. Also, an absolute value of the equation 2 can represent the energy value Eo of the first laser beam indicated by the digital data from the ADC 36. The equation 3 can represent a degree I(t) per unit time of the energy value P of the laser beam made up of the first reference beam and the first laser beam. The equation 4 is generated by expanding the I(t) into a form including phases. Therefore, by performing integration of the equation indicating the i (t) with the time t, the energy value P can be calculated for the laser beam made up of the first reference beam and the first laser beam. In other words, the energy value can be calculated for the laser beam made up of the data beam and the second reference beam illuminating the hologram recording medium 22. FIG. 6 is a graphic representation of FIG. 4. Referring to the equation 4 indicating the i (t) using FIG. 6, it can be seen, as shown in FIG. 6, that the i (t) will be a maximum value when Ar²+Ao²+2·Ar·Ao and will be a minimum value when Ar²+Ao²−2·Ar·Ao. Therefore, one (1) page of a hologram (interference fringe) formed in the hologram recording medium 22 is formed from the maximum value (e.g., a peak of the interference fringe (a of FIG. 6)) and the minimum value (e.g., a trough of the interference fringe (b of FIG. 6)). By the way, in the formation of the hologram in the hologram recording medium 22, it is desirable to form the hologram with the highest diffraction efficiency of the reference beam in the finite number of monomers. Therefore, by the equation 5 performing integration with time t of most important Ar·Ao for determining the maximum value and the minimum value of the i (t) in the equation 3 which indicates i (t), the energy value P will be calculated for the laser beam made up of the first laser beam and the first reference beam at this time, for convenience sake. In the implementation, the energy value P of the laser beam made up of the first laser beam and the first reference beam is calculated from the equation 5 as described above, the present invention is not limited to this. Of course, the equation 4 indicating i (t) may be provided such that the calculation is performed with the use of the equation 4. To the DSP 37, a reference energy value read out from the memory 2 is sent from the CPU 1 corresponding to a page for forming the hologram. The DSP 37 determines whether the energy value P of the laser beam made up of the first laser beam and the first reference beam calculated as above reaches the reference energy value from the CPU 1 or not. If the DSP 37 determines that the calculated energy value P has not reached to the reference energy value, then, for example, the DSP 37 stores the calculated energy value P into a register (not shown) and calculates an energy value P again based on the digital data from the ADC 35 and the digital data from the ADC 36. Then, the DSP 37 multiplies the calculated energy value P and the energy value P stored in the register and determines again whether the energy value P as a result of the multiplication reaches to the reference energy value or not. If the DSP 37 determines that the calculated energy value P has reached to the reference energy value, the DSP 37 sends to the first shutter control unit 12 an instruction signal for closing the first shutter 11. Alternatively, if the DSP 37 determines that the calculated energy value P has not reached to the reference energy value, the DSP 37 calculates an energy value P made up of the first laser beam and the first reference beam again based on the digital data from the ADC 35 and the digital data from the ADC 36. The DSP 37 sends to the first shutter control unit 12 the instruction signal for closing the first shutter 11 based on an instruction signal from the CPU 1. In the implementation, the energy value P of the laser beam made up of the first laser beam and the first reference beam is calculated by providing the DSP 37, the present invention is not limited to this. Any configuration for processing digital data may be used and, for example, a microcomputer may be provided such that the calculation is performed by the microcomputer for the energy value P of the first laser beam and the first reference beam.

The detector 23 is illuminated by the servo laser beam after the servo laser beam illuminates the pits indicating the address information formed in the hologram recording medium 22. The detector 23 consists of, for example, a light detector divided into four (4) pieces (not shown) and sends to the disk control unit 24 the light intensity information of the servo laser beam detected by the light detector divided into four (4) pieces. Also, the detector 23 sends the address information to the CPU 1 based on the servo laser beam which has illuminated the pit indicating the address information.

The disk control unit 24 performs servo control for the disk drive unit 25 based on the light intensity information of the servo laser beam. Also, at the time of reproduction, the disk control unit 24 sends to the disk drive unit 25 an instruction signal for rotating the hologram recording medium 22, in order to irradiate the servo laser beam to the pit indicating desired address information in the hologram recording medium 22. Also, when the book described above is formed in the hologram recording medium 22, the disk control unit 24 sends to the disk drive unit 25 an instruction signal for rotating the hologram recording medium 22, in order to form holograms at other locations in the hologram recording medium 22.

<Operations of Hologram Apparatus>

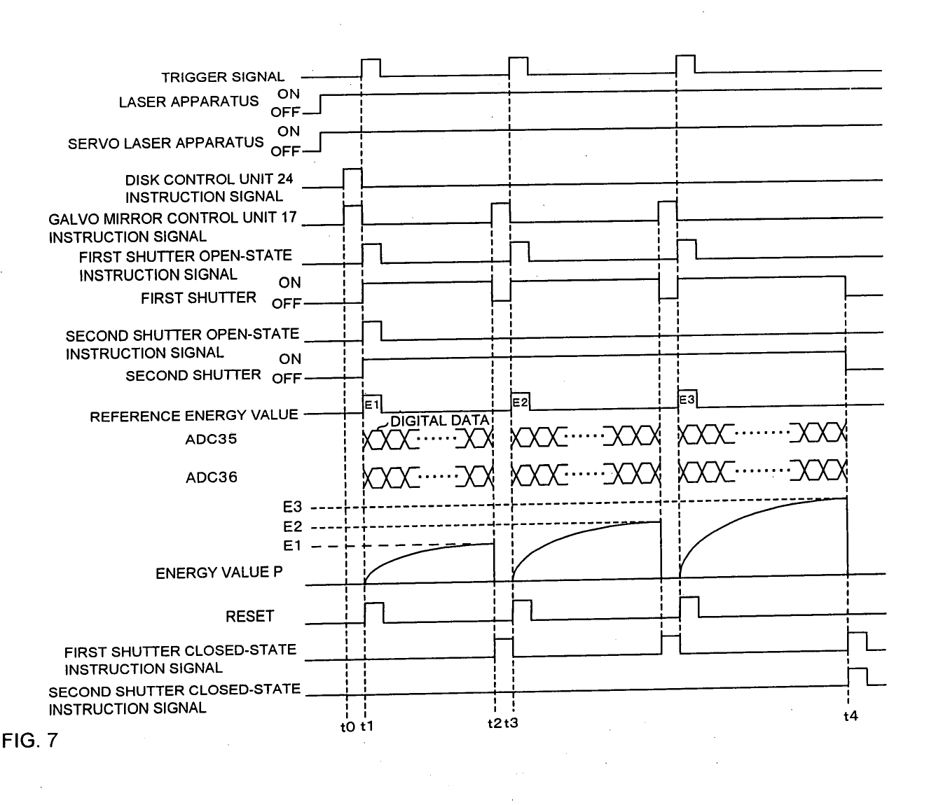

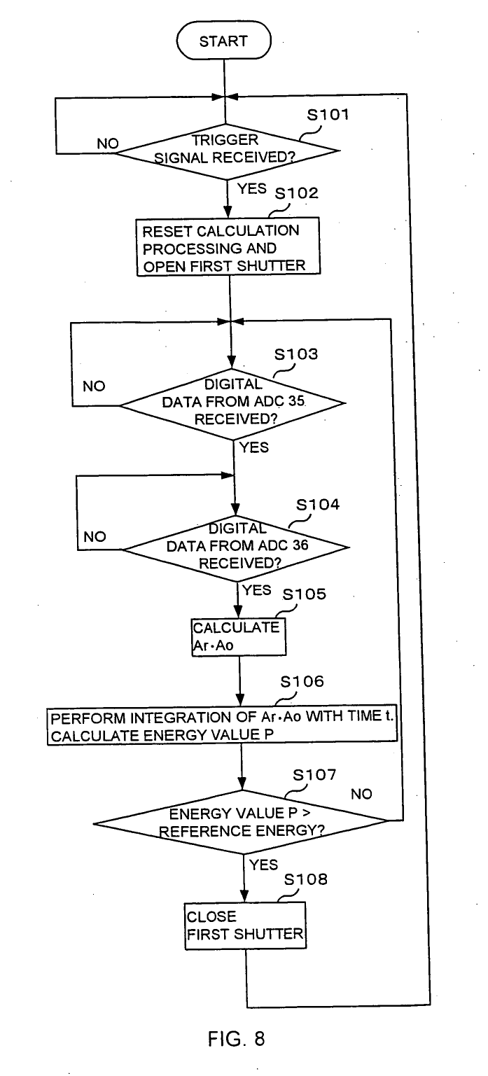

Referring to FIG. 1, FIG. 7 and FIG. 8, operations of the hologram apparatus according to the present invention are described. FIG. 7 is a timing chart showing an example of operations of the hologram apparatus according to the present invention. FIG. 8 is a flowchart showing an example of operations of the DSP 37 constituting the hologram apparatus according to the present invention. In the implementation, it is assumed in this description that a hologram is not formed (i.e., data is not recorded) in the hologram recording medium 22.

When recording-instructed data is stored in the buffer 5 via the connection terminal 4 and the interface 3 from the host equipment such as PC for example, the reproducing/recording determination unit 6 determines that the recording-instructed data is stored in the buffer 5. Then, the reproducing/recording determination unit 6 sends to the CPU 1 an instruction signal for executing the recording processing in the hologram apparatus. It is assumed that the buffer 5 has stored data to be recorded in the hologram recording medium 22, which have been sent from the host equipment. The reproducing/recording determination unit 6 sends to the CPU 1 the information of an amount of the data to be stored in the hologram recording medium 22. Then, the reproducing/recording determination unit 6 sends to the encoder 7 the data to be stored in the hologram recording medium 22, which have been stored in the buffer 5.

When receiving the instruction signal based on the recording-instructed data from the reproducing/recording determination unit 6, the CPU 1 reads out the address information of holograms already formed in the hologram recording medium 22 out of the address information stored in the memory 2. In the implementation, since a hologram is not yet formed in the hologram recording medium 22 as described above, the CPU 1 will determine that the information of holograms already formed in the hologram recording medium 22 does not exist. Then, the CPU 1 sends instruction signals to the galvo mirror control unit 17 and the disk control unit 24 (in FIG. 7, disk control unit 24 instruction signal (t0), galvo mirror control unit 17 instruction signal (t0)) in order to start formation of the hologram from a location in the hologram recording medium 22 where first address information is formed as a pit. Also, the CPU 1 sends to the second shutter control unit 15 the instruction signal for opening the second shutter 14. The CPU 1 sends a trigger signal to the DSP 37 in order to open the first shutter 11 (trigger signal (t1) in FIG. 7). Further, the CPU 1 calculates the number of pages to be formed in the hologram recording medium 22 based on the information of the data amount from the reproducing/recording determination unit 6. In the implementation, it is assumed in this description that the information of the data amount is the information for four (4) megabits and that the CPU 1 calculates three (3) pages at this time. Then, for each page constituting the book in the angle-multiplexed recording, the CPU 1 reads out from the memory 2 the optimum reference energy values of the laser beam made up of the data beam and the second reference beam, which are obtained from experiments and the like, corresponding to the each page. In the implementation, firstly, the CPU 1 reads out from the memory 2 and sends to the DSP 37 (reference energy (E1) in FIG. 7) the reference energy value E1 corresponding to a first page (a first hologram to be formed in the hologram recording medium 22).

The servo laser apparatus 19 irradiates the servo laser beam as the hologram apparatus is started up (servo laser apparatus in FIG. 7). The servo laser beam is reflected by the dichroic mirror 18 and applied to the scanner lens 20. The servo laser beam applied to the scanner lens 20 illuminates the pit indicating the address information formed in the hologram recording medium 22 and is applied to the detector 23.

The detector 23 sends the address information to the CPU 1 based on the servo laser beam which has illuminated the pit indicating the address information and which has been applied to the light detector divided into four (4) pieces (not shown) constituting the detector 23. Also, the detector 23 sends to the disk control unit 24 the light intensity information of the servo laser beam detected by the light detector divided into four (4) pieces.

The CPU 1 determines whether the address information indicates the first address information or not, based on the address information from the detector 23. When determining that the address information does not indicate the first address information, the CPU 1 sends an instruction signal to the disk control unit 24 in order to rotate the hologram recording medium 22 and to irradiate the servo laser beam to the pit indicating the first address.

The disk control unit 24 sends to the disk drive unit 25 an instruction signal in order to rotate the hologram recording medium 22 based on the instruction signal from the CPU 1. Also, the disk control unit 24 determines whether a tilt correction will be performed for the hologram recording medium 22 or not, based on the light intensity information from the detector 23. In the implementation, it is assumed in the following description that the disk control unit 24 determines that the light intensity of the servo laser beam indicated by the light intensity information from the detector 23 has reached to or exceeded a predetermined value and determines that the tilt correction is not needed for the hologram recording medium 22.

The disk drive unit 25 rotates the hologram recording medium 22 based on the instruction signal from the disk control unit 24.

The encoder 7 performs encode processing for the data from the buffer 5.

The map processing unit 8 rearranges the data from the encoder 7 to a two-dimensional data array to form unit-page array data. In the implementation, it is assumed in this description that the map processing unit 8 can form the unit-page array data from data of 1638400 bits (1280 bits×1280 bits). Therefore, when the data of four (4) megabits will be stored in the hologram recording medium 22 from the host equipment, the map processing unit 8 sequentially forms the unit-page array data for at least three (3) times.

The SLM 9 forms a two-dimensional gray image pattern (1280 bits of height×1280 bits of width) based on the unit-page array data formed in the map processing unit 8. The two-dimensional gray image pattern is formed by, for example, allocating “brightness” to one logical value of the data constituting the unit-page array data and “darkness” to the other logical value.

When receiving the trigger signal from the CPU 1 (S101, YES), the DSP 37 sends to the first shutter control unit the instruction signal for opening the first shutter 11 as well as resets the calculation processing of the energy value P (S102, reset (t1) in FIG. 7).

The first shutter control unit 12 sends the open-state instruction signal to the first shutter 11 (first shutter open-state instruction signal (t1) in FIG. 7) based on the instruction signal from the DSP 37. The first shutter 11 enters into the open state (ON) based on the open-state instruction signal from the first shutter control unit 12 (first shutter (t1) in FIG. 7). By the first shutter 11 entering into the open state, a laser beam from the laser apparatus 10 is applied to the ½ wavelength plate 43 via the first shutter 11.

The ½ wavelength plate 43 irradiates the laser beam from the laser apparatus 10 to the PBS 13 at an angle corresponding to a predetermined tilt.

The PBS 13 splits the laser beam from the ½ wavelength plate 43 into one laser beam and a reference beam, irradiates the one laser beam to the ½ wavelength plate 45 and irradiates the reference beam to the ½ wavelength plate 44.

The ½ wavelength plate 45 irradiates the one laser beam from the PBS 13 to the PBS 32 at an angle corresponding to a predetermined tilt.

The PBS 32 splits the one laser beam from the ½ wavelength plate 45 into a first laser beam and a second laser beam, irradiates the first laser beam to the photo detector 34 and irradiates the second laser beam to the second shutter.

The second shutter control unit 15 sends the open-state instruction signal to the second shutter 14 (the second shutter open-state instruction signal (t1) in FIG. 7) based on the instruction signal from the CPU 1.

The second shutter 14 enters into the open state (ON) based on the open-state instruction signal from the second shutter control unit 15 (second shutter (t1) in FIG. 7). By the second shutter 14 entering into the open state, the second laser beam from the PBS 32 is applied to the SLM 9.

When illuminated by the second laser beam, the SLM 9 reflects the second laser beam to the Fourier transform lens 21 as the data beam reflecting the information of the two-dimensional gray image pattern formed in the SLM 9.

While the Fourier transform lens 21 focuses the data beam from the SLM 9, the data beam is subjected to the Fourier transform and applied to the hologram recording medium 22.

The ½ wavelength plate 44 irradiates the reference beam from the PBS 13 to the PBS 31 at an angle corresponding to a predetermined tilt.

The PBS 31 splits the reference beam from the ½ wavelength plate 44 into the first reference beam and the second reference beam, irradiates the first reference beam to the photo detector 33 and irradiates the second reference beam to the galvo mirror 16.

The galvo mirror control unit 17 adjusts an angle of the galvo mirror 16, in order to adjust an angle at which the second reference beam reflected by the galvo mirror 16 is applied to the hologram recording medium 22 via the dichroic mirror 18 and the scanner lens 20, based on the instruction signal from the CPU 1. At this time, the angle adjustment of the galvo mirror 16 with the galvo mirror control unit 17 is performed in order to form the first page in the hologram recording medium 22 as described above. The second reference beam from the PBS 31 is reflected by the galvo mirror 16 with an angle adjusted by the galvo mirror control unit 17 and applied to the dichroic mirror 18.

The second reference beam applied to the dichroic mirror 18 is transmitted through the dichroic mirror 18 and applied to the scanner lens 20.

The scanner lens 20 deflects the second reference beam from the dichroic mirror 18 and irradiates the second reference beam into the hologram recording medium 22.

The photo detector 34 converts the first laser beam from the PBS 32 into an analog electric signal corresponding to a light intensity of the first laser beam and sends the analog electric signal to the ADC 36.

The ADC 36 converts the analog electric signal from the photo detector 34 into digital data corresponding to the analog electric signal and sends the digital data to the DSP 37 (ADC 36 (t1) in FIG. 7).

The photo detector 33 converts the first reference beam from the PBS 31 into an analog electric signal corresponding to a light intensity of the first reference beam and sends the analog electric signal to the ADC 35.

The ADC 35 converts the analog electric signal from the photo detector 33 into digital data corresponding to the analog electric signal and sends the digital data to the DSP 37 (ADC 35 (t1) in FIG. 7).

To the DSP 37, the digital data corresponding to a light intensity of the first reference beam is sent from the ADC 35 (S103, YES). Also, to the DSP 37, the digital data corresponding to a light intensity of the first laser beam is sent from the ADC 36 (S104, YES). Based on the digital data from the ADC 35 and the digital data from the ADC 36, the DSP 37 calculates the energy value P of the laser beam made up of the first reference beam and the first laser beam. In the calculation of the energy value P, as described above, Ar·Ao is calculated (S105) by multiplying the energy value Er of the first reference beam indicated by the digital data from the ADC 35 (equation 1) and the energy value Eo of the first laser beam indicated by the digital data from the ADC 36 (equation 2). Then, by performing integration of the calculated Ar·Ao with time t (equation 5), the energy value P of the laser beam made up of the first reference beam and the first laser beam is calculated (S106). Therefore, an energy value of the laser beam made up of the data beam and the second reference beam is calculated by the DSP 37. Then, the DSP 37 determines whether the calculated energy value P reaches to a reference energy value E1 from the CPU 1 or not (S107). If the DSP 37 determines that the calculated energy value P has not reached to the reference energy value E1 (S107, NO), then, for example, the DSP 37 stores the calculated energy value P into a register (not shown) and calculates an energy value P again based on the digital data from the ADC 35 and the digital data from the ADC 36. Then, the DSP 37 multiplies the calculated energy value P and the energy value P stored in the register and determines again whether the energy value P as a result of the multiplication has reached to the reference energy value or not. If the DSP 37 determines that the calculated energy value P is equal to or less than the reference energy value E1, the interference fringe having diffraction efficiency of a predetermined value X is not formed by the energy value of the laser beam made up of the data beam and the second reference beam currently illuminating the hologram recording medium 22. Therefore, the DSP 37 does not send the instruction signal for putting the first shutter 11 into the closed state (OFF) in order to continuously irradiate the laser beam made up of the data beam and the second reference beam into the hologram recording medium 22. If the DSP 37 determines that the calculated energy value P reaches to the reference energy value E1 (S107, YES), the DSP 37 sends an instruction signal for closing the first shutter 11 to the first shutter control unit 12 and the CPU 1. In other words, the interference fringe (i.e., first page) having diffraction efficiency of a predetermined value X has been formed by the energy value of the laser beam made up of the data beam and the second reference beam illuminating the hologram recording medium 22.

The first shutter control unit 12 sends the closed-state instruction signal to the first shutter 11 (first shutter closed-state instruction signal (t2) in FIG. 7) based on the instruction signal from the DSP 37.

The first shutter 11 enters into the closed state based on the closed-state instruction signal from the first shutter control unit 12 (first shutter (t2) in FIG. 7).

Then, based on the instruction signal from the DSP 37, the CPU 1 sends to the galvo mirror control unit 17 an instruction signal for changing an angle of the galvo mirror 16 (galvo mirror control unit 17 instruction signal (t2) in FIG. 7), in order to form a second page of hologram (a second hologram to be formed in the hologram recording medium 22) in the hologram recording medium 22. Also, the CPU 1 sends the trigger signal described above to the DSP 37 (trigger signal (t3) in FIG. 7). Further, the CPU 1 reads out from the memory 2 and sends to the DSP 37 a reference energy value E2 corresponding to the second page (reference energy value (E2) in FIG. 7).

Then, the second page is formed in the hologram recording medium 22 in the same way as the processing for storing the first page into the hologram recording medium 22, as described above. The processing for forming a third page in the hologram recording medium 22 is the same as the processing for storing the second page into the hologram recording medium 22.

When receiving an instruction signal from the DSP 37 after the third page is formed in the hologram recording medium 22, the CPU 1 determines that the holograms are formed in the hologram recording medium 22 for the number of the pages calculated based on the information of the data amount from the reproducing/recording determination unit 6 described above and sends to the second shutter control unit 15 the instruction signal for closing the second shutter 14.

The second shutter control unit 15 sends the closed-state instruction signal to the second shutter 14 (second shutter closed-state instruction signal (t4) in FIG. 7) based on the instruction signal from the CPU 1.

The second shutter 14 enters into the closed state based on the closed-state instruction signal from the second shutter control unit 15 (second shutter (t4) in FIG. 7).

In this way, the DSP 37 can calculate the energy value of the laser beam made up of the data beam and the second reference beam currently illuminating the hologram recording medium 22 from the energy value Er of the first reference beam split in the PBS 31 obtained by splitting in the PBS 31 the reference beam which has been split from the laser beam irradiated from the laser apparatus 10 and the energy value Eo of the first laser beam split in PBS 32 obtained by splitting one of laser beams in the PBS 32. Then, numerous interference fringes having diffraction efficiency of a predetermined value X can be formed in the hologram recording medium 22 from the energy value P calculated in the DSP 37 and the reference energy value corresponding to the page to be formed by the laser beam made up of the data beam and the second reference beam. Therefore, a large amount of data can be recorded in the hologram recording medium 22 by efficiently using the finite number of monomers existing in the hologram recording medium 22.

Also, according to the first implementation described above, the laser beam can be controlled as described above by software incorporated into the DSP 37, based on the digital data from the ADC 35 and the ADC 36.

### SECOND IMPLEMENTATION

<Overall Configuration of Hologram Apparatus>

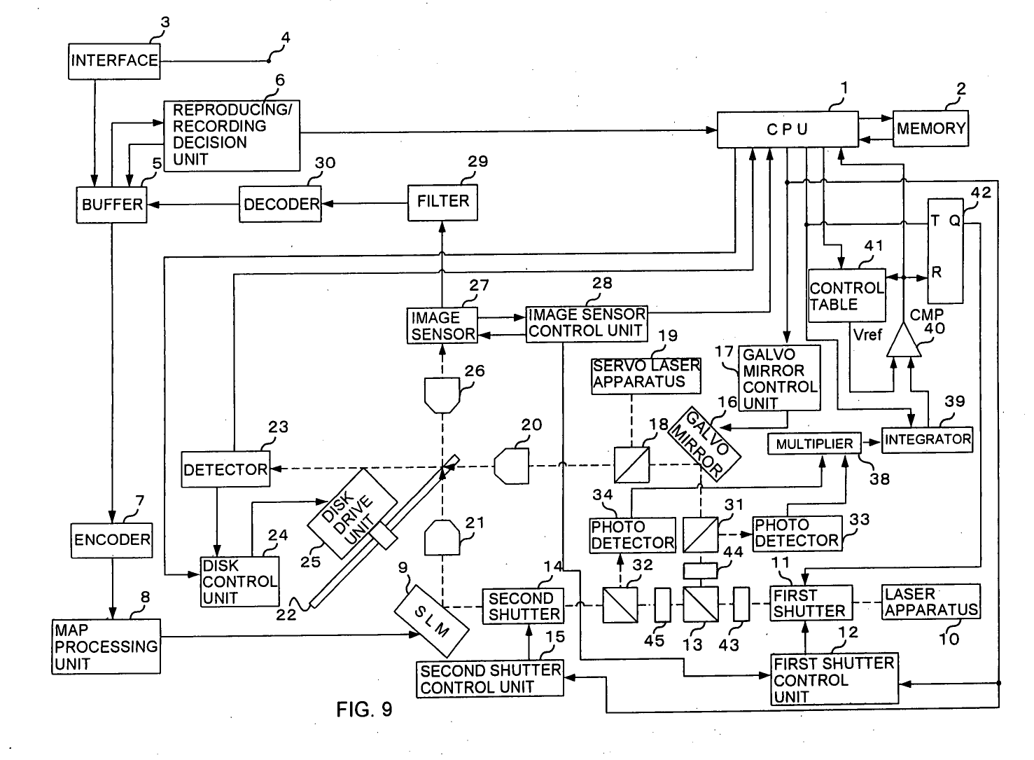

Referring to FIG. 9, a hologram apparatus according to the present invention is described. FIG. 9 is a functional block diagram showing an example of an entire configuration of the hologram apparatus according to the second implementation of the present invention. To portions of FIG. 9 which have the same configuration as FIG. 1, the same numbers are added and a description for the portions is omitted.

The hologram apparatus has a CPU 1, a memory 2, an interface 3, a connection terminal 4, a buffer 5, a reproducing/recording determination unit 6, an encoder 7, a map processing unit 8, an SLM 9, a laser apparatus 10, a first shutter 11, a first shutter control unit 12, PBS 13, 31 and 32, a second shutter 14, a second shutter control unit 15, a galvo mirror 16, a galvo mirror control unit 17, a dichroic mirror 18, a servo laser apparatus 19, a scanner lens 20, Fourier transform lenses 21 and 26, a detector 23, a disc control unit 24, a disc drive unit 25, an image sensor 27, an image sensor control unit 28, a filter 29, a decoder 30, ½ wavelength plates 43, 44 and 45, photo detectors 33 and 34, a multiplier 38 (determination unit), an integrator 39 (determination unit), a comparator 40 (determination unit), a control table 41 (light intensity calculation unit), a TFF (toggle flip-flop) 42 (determination unit).

To the multiplier 38, an analog electric signal is input corresponding to a light intensity of a first reference beam from the photo detector 33. Also, to the multiplier 38, an analog electric signal is input corresponding to a light intensity of a first laser beam from the photo detector 34. The multiplier 38 calculates an analog electric signal indicating Ar·Ao from the analog electric signal from the photo detector 33 and the analog electric signal from the photo detector 34, based on the equation 4 described in the first implementation.

To the integrator 39, a trigger signal is input from the CPU 1. When the trigger signal is input from the CPU 1, the integrator 39, for example, discharges an integral voltage obtained from a result of integration described below. The integrator 39 performs integration of the calculation result from the multiplier 38 with time t, based on the equation 5 described in the first implementation. Then, the integrator 39 outputs the integral voltage obtained from the result of the integration to the comparator 40. In other words, the result of the integration of the integrator 39 is an analog electric signal with a level corresponding to an energy value P of a laser beam made up of the first reference beam and the first laser beam.

The TFF 42 has a T terminal (trigger input), R terminal (reset input) and Q terminal (output terminal). To the T terminal of the TFF 42, a trigger signal is input from the CPU 1. When the trigger signal is input from the CPU 1, the TFF 42 outputs a high level from the Q terminal to open the first shutter 11, for example. The first shutter 11 is in an open state while the high level is being output from the TFF 42. Also, when a comparison output signal is input from the comparator 40 to the R terminal, the TFF 42 outputs a low level from the Q terminal to close the first shutter 11, for example. The first shutter 11 is in a closed state while the low level is being output from the TFF 42.

To the control table 41, page data are input from the CPU 1. The page data are information corresponding to a page (e.g., a second page) to be formed in the hologram recording medium 22 by the CPU 1 out of the number of pages calculated by the CPU 1 based on information of a data amount from the reproducing/recording determination unit 6, as described in the first implementation. Based on the page data, the control table 41 outputs a reference voltage Vref corresponding to the page data to the comparator 40. Therefore, the reference voltage Vref output from the control table 41 corresponds to a reference energy value corresponding to each page, as described in the first implementation. Also, the control table 41 suspends the output of the reference voltage Vref to the comparator 40 based on the comparison output signal from the comparator 40 until next page data is input from the CPU 1.

The comparator 40 compares the reference voltage Vref from the control table 41 with the integral voltage from the integrator 39. If a level of the integral voltage from the integrator 39 is higher than the reference voltage Vref from the control table 41, the comparator 40 outputs the comparison output signal to the TFF 42, the CPU 1 and the control table 41.

<Operations of Hologram Apparatus>

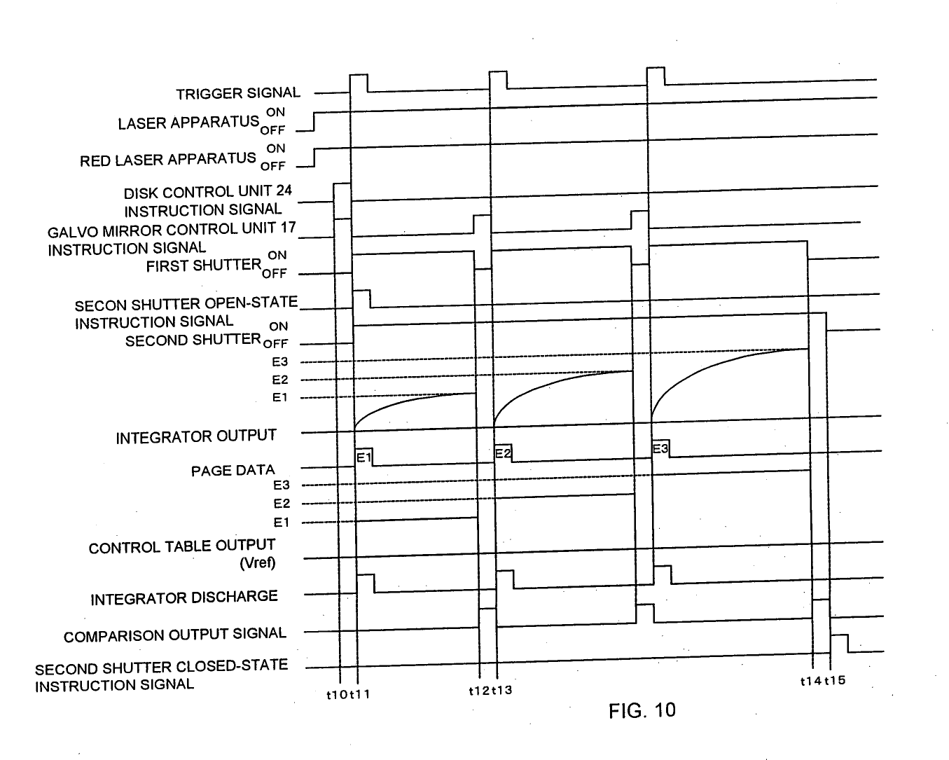

Referring to FIG. 9 and FIG. 10, operations of the hologram apparatus according to the present implementation are described. FIG. 10 is a timing chart showing an example of operations of the hologram apparatus according to the present implementation. In the implementation, it is assumed in this description that a hologram is not formed (i.e., data is not stored) in the hologram recording medium 22.

When recording-instructed data is stored in the buffer 5 via the connection terminal 4 and the interface 3 from the host equipment such as PC for example, the reproducing/recording determination unit 6 determines that the recording-instructed data is stored in the buffer 5. Then, the reproducing/recording determination unit 6 sends to the CPU 1 an instruction signal for executing the recording processing in the hologram apparatus. It is assumed that the buffer 5 has stored data to be recorded in the hologram recording medium 22, which have been sent from the host equipment. The reproducing/recording determination unit 6 sends to the CPU 1 the information of an amount of the data to be stored in the hologram recording medium 22. Then, the reproducing/recording determination unit 6 sends to the encoder 7 the data to be stored in the hologram recording medium 22, which have been stored in the buffer 5.

When receiving the instruction signal based on the recording-instructed data from the reproducing/recording determination unit 6, the CPU 1 reads out the address information of holograms already formed in the hologram recording medium 22 out of the address information stored in the memory 2. In the implementation, since a hologram is not yet formed in the hologram recording medium 22 as described above, the CPU 1 will determine that the information of holograms already formed in the hologram recording medium 22 does not exist. Then, the CPU 1 sends instruction signals to the galvo mirror control unit 17 and the disk control unit 24 (disk control unit 24 instruction signal (t10), galvo mirror control unit 17 instruction signal (t10) in FIG. 10) in order to start formation of the hologram from a location in the hologram recording medium 22 where first address information is formed as a pit. Also, the CPU 1 sends to the second shutter control unit 15 the instruction signal for opening the second shutter 14. The CPU 1 sends a trigger signal to the TFF 42 in order to put the first shutter 11 into an open state (ON) (trigger signal (t11) in FIG. 10) as well as sends the trigger signal to the integrator 39. Further, the CPU 1 calculates the number of pages to be formed in the hologram recording medium 22 based on the information of the data amount from the reproducing/recording determination unit 6. In the implementation, it is assumed in this description that the information of the data amount is the information for four (4) megabits and that the CPU 1 calculates three (3) pages at this time. Firstly, the CPU 1 sends to the control table 41 the information corresponding to a first page (first hologram to be formed in the hologram recording medium 22) as the page data (page data (E1) in FIG. 10).

The servo laser apparatus 19 irradiates the servo laser beam as the hologram apparatus is started up (servo laser apparatus in FIG. 10). The servo laser beam is reflected by the dichroic mirror 18 and applied to the scanner lens 20. The servo laser beam applied to the scanner lens 20 illuminates the pit indicating the address information formed in the hologram recording medium 22 and is applied to the detector 23.

The detector 23 sends the address information to the CPU 1 based on the servo laser beam which has illuminated the pit indicating the address information and which has been applied to the light detector divided into four (4) pieces (not shown) constituting the detector 23. Also, the detector 23 sends to the disk control unit 24 the light intensity information of the servo laser beam detected by the light detector divided into four (4) pieces.

The CPU 1 determines whether the address information indicates the first address information or not, based on the address information from the detector 23. When determining that the address information does not indicate the first address information, the CPU 1 sends an instruction signal to the disk control unit 24 in order to rotate the hologram recording medium 22 and to irradiate the servo laser beam to the pit indicating the first address.

The disk control unit 24 sends to the disk drive unit 25 an instruction signal in order to rotate the hologram recording medium 22 based on the instruction signal from the CPU 1. Also, the disk control unit 24 determines whether a tilt correction will be performed for the hologram recording medium 22 or not, based on the light intensity information from the detector 23. In the implementation, it is assumed in the following description that the disk control unit 24 determines that the light intensity of the servo laser beam indicated by the light intensity information from the detector 23 has reached to or exceeded a predetermined value and determines that the tilt correction is not needed for the hologram recording medium 22.

The disk drive unit 25 rotates the hologram recording medium 22 based on the instruction signal from the disk control unit 24.

The encoder 7 performs encode processing for the data from the buffer 5.

The map processing unit 8 rearranges the data from the encoder 7 to a two-dimensional data array to form unit-page array data. In the implementation, it is assumed in this description that the map processing unit 8 can form the unit-page array data from data of 1638400 bits (1280 bits×1280 bits). Therefore, when the data of four (4) megabits will be stored in the hologram recording medium 22 from the host equipment, the map processing unit 8 sequentially forms the unit-page array data for at least three (3) times.

The SLM 9 forms a two-dimensional gray image pattern (1280 bits of height×1280 bits of width) based on the unit-page array data formed in the map processing unit 8. The two-dimensional gray image pattern is formed by, for example, allocating “brightness” to one logical value of the data constituting the unit-page array data and “darkness” to the other logical value.

When the trigger signal is input from the CPU 1, the integrator 39 discharges the integral voltage obtained from the result of the integration (integrator discharge (t11) in FIG. 10).

When the trigger signal is input from the CPU 1, the TFF 42 outputs a high level to open the first shutter (first shutter (t11) in FIG. 10). By the first shutter 11 entering into the open state, a laser beam from the laser apparatus 10 is applied to the ½ wavelength plate 43 via the first shutter 11. The first shutter 11 is in the open state while the high level is being output from the TFF 42, as described above.

The ½ wavelength plate 43 irradiates the laser beam from the laser apparatus 10 to the PBS 13 at an angle corresponding to a predetermined tilt.

The PBS 13 splits the laser beam from the ½ wavelength plate 43 into one laser beam and a reference beam, irradiates the one laser beam to the ½ wavelength plate 45 and irradiates the reference beam to the ½ wavelength plate 44.

The ½ wavelength plate 45 irradiates the one laser beam from the PBS 13 to the PBS 32 at an angle corresponding to a predetermined tilt.

The PBS 32 splits the one laser beam from the ½ wavelength plate 45 into a first laser beam and a second laser beam, irradiates the first laser beam to the photo detector 34 and irradiates the second laser beam to the second shutter.

The second shutter control unit 15 sends the open-state instruction signal to the second shutter 14 (the second shutter open-state instruction signal (t11) in FIG. 10) based on the instruction signal from the CPU 1.

The second shutter 14 enters into the open state (ON) based on the open-state instruction signal from the second shutter control unit 15 (second shutter (t11) in FIG. 10). By the second shutter 14 entering into the open state, the second laser beam from the PBS 32 is applied to the SLM 9.

When illuminated by the second laser beam, the SLM 9 reflects the second laser beam to the Fourier transform lens 21 as the data beam reflecting the information of the two-dimensional gray image pattern formed in the SLM 9.

While the Fourier transform lens 21 focuses the data beam from the SLM 9, the data beam is subjected to the Fourier transform and applied to the hologram recording medium 22.

The ½ wavelength plate 44 irradiates the reference beam from the PBS 13 to the PBS 31 at an angle corresponding to a predetermined tilt.

The PBS 31 splits the reference beam from the ½ wavelength plate 44 into the first reference beam and the second reference beam, irradiates the first reference beam to the photo detector 33 and irradiates the second reference beam to the galvo mirror 16.

The galvo mirror control unit 17 adjusts an angle of the galvo mirror 16, in order to adjust an angle at which the second reference beam reflected by the galvo mirror 16 is applied to the hologram recording medium 22 via the dichroic mirror 18 and the scanner lens 20, based on the instruction signal from the CPU 1. At this time, the angle adjustment of the galvo mirror 16 with the galvo mirror control unit 17 is performed in order to form the first page in the hologram recording medium 22 as described above. The second reference beam from the PBS 31 is reflected by the galvo mirror 16 with an angle adjusted by the galvo mirror control unit 17 and applied to the dichroic mirror 18.

The second reference beam applied to the dichroic mirror 18 is transmitted through the dichroic mirror 18 and applied to the scanner lens 20.

The scanner lens 20 deflects the second reference beam from the dichroic mirror 18 and irradiates the second reference beam into the hologram recording medium 22.

The photo detector 34 converts the first laser beam from the PBS 32 into an analog electric signal corresponding to a light intensity of the first laser beam and sends the analog electric signal to the multiplier 38.

The photo detector 33 converts the first reference beam from the PBS 31 into an analog electric signal corresponding to a light intensity of the first reference beam and sends the analog electric signal to the multiplier 38.

The multiplier 38 calculates an analog electric signal indicating Ar·Ao from the analog electric signal from the photo detector 33 and the analog electric signal from the photo detector 34 based on the equation 4 and sends the analog electric signal to the integrator 39.

The integrator 39 performs integration of the calculation result from the multiplier 38 with time t and outputs the integral voltage obtained from the result of the integration to the comparator 40.

When page data are input from the CPU 1, the control table 41 outputs a reference voltage Vref corresponding to the first page to the comparator 40 (control table output (Vref) (t11) in FIG. 10).

The comparator 40 compares the reference voltage Vref from the control table 41 with the integral voltage from the integrator 39. If a level of the integral voltage from the integrator 39 is higher than the reference voltage Vref from the control table 41, the comparator 40 outputs the comparison output signal (CMP) to the TFF 42, the CPU 1 and the control table 41 (comparison output signal (t12)). Specifically, if the comparison output signal is not output from the comparator 40 to the TFF 42, the interference fringe having diffraction efficiency of a predetermined value X is not formed by the energy value of the laser beam made up of the data beam and the second reference beam currently illuminating the hologram recording medium 22. Therefore, from the comparator 40, the comparison output signal is not output in order to continuously irradiate the laser beam made up of the data beam and the second reference beam into the hologram recording medium 22. If the comparison output signal is output from the comparator 40 to the TFF 42, the control table 41 and the CPU 1, the interference fringe (i.e., first page) having diffraction efficiency of a predetermined value X is formed by the energy value of the laser beam made up of the second data beam and the second reference beam currently illuminating the hologram recording medium 22.

When the comparison output signal is input from the comparator 40, the TFF 42 outputs a low level to close the first shutter 11 (first shutter (t12) in FIG. 10). As described above, the first shutter 11 is in the closed state while the low level is being output from the TFF 42. When the comparison output signal is input from the comparator 40, the control table 41 suspends the output of the reference voltage Vref to the comparator 40 until next page data is input from the CPU 1 (control table (t12) in FIG. 10).

Then, based on the comparison output signal from the comparator 40, the CPU 1 sends to the galvo mirror control unit 17 an instruction signal for changing an angle of the galvo mirror 16 (galvo mirror control unit 17 instruction signal (t12) in FIG. 10), in order to form a second page of hologram (a second hologram to be formed in the hologram recording medium 22) in the hologram recording medium 22. Also, the CPU 1 sends the trigger signal described above to the TFF 42 and the control table 41 (trigger signal (t13) in FIG. 10). Further, the CPU 1 sends the information corresponding to the second page to the control table 41 as the page data (page data (E2) in FIG. 10).

Then, the second page is formed in the hologram recording medium 22 in the same way as the processing for storing the first page into the hologram recording medium 22, as described above. The processing for forming a third page in the hologram recording medium 22 is the same as the processing for storing the second page into the hologram recording medium 22.

The CPU 1 receives the comparison output signal from the comparator 40 after the third page is formed in the hologram recording medium 22 (comparison output signal (t14) in FIG. 10). Then, the CPU 1 determines that the holograms are formed in the hologram recording medium 22 for the number of the pages calculated based on the information of the data amount from the reproducing/recording determination unit 6 described above and sends to the second shutter control unit 15 the instruction signal for closing the second shutter 14.

The second shutter control unit 15 sends the closed-state instruction signal to the second shutter 14 (second shutter closed-state instruction signal (t15) in FIG. 10) based on the instruction signal from the CPU 1.

The second shutter 14 enters into the closed state based on the closed-state instruction signal from the second shutter control unit 15 (second shutter (t15) in FIG. 10).

In this way, the integrator 39 can calculate the electric analog signal corresponding to the energy value of the laser beam made up of the data beam and the second reference beam currently illuminating the hologram recording medium 22 from the analog electric signal indicating the light intensity of the first reference beam split in the PBS 31 obtained by splitting in the PBS 31 the reference beam which has been split from the laser beam irradiated from the laser apparatus 10 and the analog electric signal indicating the light intensity of the first laser beam split in the PBS 32 obtained by splitting one of laser beams in the PBS 32. Then, numerous interference fringes having diffraction efficiency of a predetermined value X can be formed in the hologram recording medium 22 from the analog electric signals calculated in the integrator 39 and the reference voltage Vref corresponding to the page from the control table 41. Therefore, a large amount of data can be recorded in the hologram recording medium 22 by efficiently using the finite number of monomers existing in the hologram recording medium 22.

Also, the laser beam can be controlled as described above by using hardware of the multiplier 38, the integrator 39, comparator 40, the TFF 42 and the control table 41, based on the analog electric signals from the photo detectors 33 and 34.

According to the first and second implementations described above, based on the analog electric signals detected by the photo detectors 33 and 34, the holograms having diffraction efficiency of a predetermined value X can be formed in the hologram recording medium 22. As a result, holograms having greater diffraction efficiency than the predetermined value X can be prevented from being formed in the hologram recording medium 22, and consumption of the monomers can be controlled.

Also, based on the analog electric signal of the first reference beam detected by the photo detector 33 and the analog electric signal of the first laser beam detected by the photo detector 34, an accurate energy value can be obtained for the data beam and the second reference beam applied to the hologram recording medium 22. Therefore, the holograms having diffraction efficiency of a predetermined value X can be formed in the hologram recording medium 22. As a result, holograms having greater diffraction efficiency than the predetermined value X can be prevented from being formed in the hologram recording medium 22, and consumption of the monomers can be controlled.

Further, based on the analog electric signal of the first laser beam split in the PBS 32 and the analog electric signal of the second reference beam split in the PBS 31, the holograms having diffraction efficiency of a predetermined value X can be formed in the hologram recording medium 22. As a result, holograms having greater diffraction efficiency than the predetermined value X can be prevented from being formed in the hologram recording medium 22, and consumption of the monomers can be controlled.

Yet further, the holograms having diffraction efficiency of a predetermined value X can be formed in the hologram recording medium 22 for the number of pages calculated by the CPU 1. As a result, holograms having greater diffraction efficiency than the predetermined value X can be prevented from being formed in the hologram recording medium 22, and consumption of the monomers can be controlled.

Moreover, the data from the host equipment can be recorded in holograms of the number of the pages calculated by the page number calculation unit, and each hologram can be the hologram having diffraction efficiency of a predetermined value X. As a result, holograms having greater diffraction efficiency than the predetermined value X can be prevented from being formed in the hologram recording medium 22, and consumption of the monomers can be controlled.

Further, by providing only the first shutter 11, the laser beam can be blocked; a cost for providing shutters can be reduced; and the configuration of the hologram apparatus can be prevented from being complicated.

Yet further, the light intensity of the first laser beam can be Er=|Ar·exp (−jωt+φr)|; the light intensity of the first reference beam can be Eo=|Ao·exp (−jωt+φo)|; and a determination can be made whether ∫Ar²+Ao²+2·Ar·Ao·cos (φr−φo)Δt has reached to the reference energy value or not.

Further, the light intensity of the first laser beam can be Er=|Ar·exp (−jωt+φr)|; the light intensity of the first reference beam can be Eo=|Ao·exp (−jωt+φo)|; and a determination can be made from ∫Ar·AoΔt which is the most important term in ∫Ar²+Ao²+2·Ar·Ao·cos (φr−φo)Δt for the analog electric signal of the first laser beam and the analog electric signal of the first reference beam whether the reference energy value is reached or not. As a result, based on the analog electric signal of the first laser beam and the analog electric signal of the first reference beam, a determination can be easily made whether the energy value of the data beam and the second reference beam has reached to the reference energy value.

<OTHER IMPLEMENTATIONS>

Although description has been made as above for the control of the laser beam applied to the hologram recording medium in the hologram apparatus according to the present invention, the above description is intended to facilitate understanding of the present invention and is not intended to limit the present invention. The present invention may be modified or altered without departing from the spirit thereof.

<Other Implementation for Split of Data Beam and Reference Beam>

Although, according to the implementations, the energy value P of the first laser beam and the first reference beam is calculated by splitting one laser beam into the first laser beam and the second laser beam in the PBS 32 and by splitting the other laser beam into the first reference beam and the second reference beam in the PBS 31, the present invention is not limited to this. For example, only the PBS 32 may be provided such that the energy value P is calculated from the energy value of the first laser beam. In this case, energy values corresponding to the energy values of the first reference beam are obtained from experiments and the like depending on the energy values of the first laser beam and are recorded as the table data in the memory, for example. Then, when the energy value of the first laser beam is calculated, the energy value obtained from the experiments and the like may be read out for calculating the energy value P. Alternatively, if a predetermined relationship exists between the energy value of the first laser beam and the energy value of the first reference beam and if the predetermined relationship can be expressed by a function, a calculation program calculating the function is recorded in advance in the memory, for example. Then, by executing the calculation program based on the energy value of the first laser beam, the energy value of the first reference beam may be calculated. As a result, by providing only the PBS 32, a determination can be made whether the reference energy value is reached or not; a cost for providing the PBS 31 can be reduced; and the configuration of the hologram apparatus can be prevented from being complicated.

Also, only the PBS 31 may be provided such that the energy value P is calculated from the energy value of the first reference beam in a similar way as the case of providing only the PBS 32, as described above. As a result, by providing only the PBS 31, a determination can be made whether the reference energy value is reached or not; a cost for providing the PBS 32 can be reduced; and the configuration of the hologram apparatus can be prevented from being complicated.

While illustrative implementations of the present invention have been described in detail herein, it is to be understood that the inventive concepts may be otherwise variously embodied and employed and that the appended claims are intended to be construed to include such variations except insofar as limited by the prior art.

What is claimed is:

1. A hologram apparatus applying a coherent data beam corresponding to data to be recorded and a coherent reference beam to a hologram recording medium to record the data in the form of a hologram in the hologram recording medium, the hologram apparatus comprising:
a light detection unit detecting a light intensity of at least one of the data beam and the reference beam;
a determination unit determining whether light intensities of the data beam and the reference beam reach to a reference value which can form a hologram having certain diffraction efficiency, based on the light intensity detected by the light detection unit; and
a block unit blocking application of at least one of the data beam and the reference beam into the hologram recording medium, based on the result of the determination of the determination unit indicating that the light intensities of the data beam and the reference beam reach to the reference value.

2. The hologram apparatus of claim 1, further comprising:
a data beam split unit splitting the data beam into a first data beam and a second data beam which is applied to the hologram recording medium, wherein
the light detection unit detects a light intensity of the first data beam, and wherein
the determination unit determines whether light intensities of the second data beam and the reference beam have reached to the reference value, based on the light intensity of the first data beam.

3. The hologram apparatus of claim 1, further comprising:
a reference beam split unit splitting the reference beam into a first reference beam and a second reference beam which is applied to the hologram recording medium, wherein
the light detection unit detects a light intensity of the first reference beam, and wherein
the determination unit determines whether light intensities of the data beam and the second reference beam have reached to the reference value, based on the light intensity of the first reference beam.

4. The hologram apparatus of claim 1, wherein
the light detection unit includes:
a first light detection unit detecting a light intensity of the data beam; and
a second light detection unit detecting a light intensity of the reference beam, and wherein
the determination unit determines whether light intensities of the data beam and the reference beam have reached to the reference value, based on the light intensity of the data beam and on the light intensity of the reference beam.

5. The hologram apparatus of claim 4, further comprising:
a data beam split unit splitting the data beam into a first data beam and a second data beam which is applied to the hologram recording medium; and
a reference beam split unit splitting the reference beam into a first reference beam and a second reference beam which is applied to the hologram recording medium, wherein
the first light detection unit detects a light intensity of the first data beam, wherein
the second light detection unit detects a light intensity of the first reference beam, and wherein
the determination unit determines whether light intensities of the second data beam and the second reference beam have reached to the reference value, based on the light intensity of the first data beam and on the light intensity of the first reference beam.

6. The hologram apparatus of claim 5, further comprising:
a page number calculation unit calculating the number of pages of holograms formed in the hologram recording medium, based on a data amount of the data; and
a light intensity calculation unit sequentially calculating the reference values depending on the number of pages calculated by the page number calculation unit, wherein
the determination unit determines whether light intensities of the second data beam and the second reference beam have reached to the reference values sequentially calculated by the light intensity calculation unit, based on the light intensity of the first data beam and on the light intensity of the first reference beam.

7. The hologram apparatus of claim 6, further comprising:
a deflection unit deflecting the reference beam or the second reference beam, in order to define an incident angle to the hologram recording medium of the second reference beam applied to the hologram recording medium; and
a deflection control unit changing a deflection angle of the deflection unit, in order to change the incident angle of the second reference beam, wherein
the deflection control unit sequentially changes the deflection angle of the deflection unit depending on the number of pages calculated by the page number calculation unit, wherein
the deflection unit sequentially deflects the reference beam or the second reference beam at deflection angles sequentially changed by the deflection control unit, and wherein
holograms are formed for the number of pages calculated by the page number calculation unit, by applying the second reference beam sequentially deflected by the deflection unit and the second data beam to the hologram recording medium, based on the light intensity of the first data beam and on the light intensity of the first reference beam, during periods sequentially determined by the determination unit.

8. The hologram apparatus of claim 5, wherein
the data beam split unit splits the data beam into the first data beam and the second data beam which have the same light intensity, and wherein
the reference beam split unit splits the reference beam into the first reference beam and the second reference beam which have the same light intensity.

9. The hologram apparatus of claim 1, wherein
the data beam and the reference beam are split from the same laser beam, and wherein
the block unit is disposed on a light path of the laser beam up to the point immediately before the laser beam is split.

10. The hologram apparatus of claim 5, wherein
let the light intensity of the first data beam detected by the first light detection unit be
Er=|Ar·exp (−jωt+φr)|

(where Ar is an amplitude of the first data beam, jωt is an angular velocity, and φr is a phase difference) and
let the light intensity of the first reference beam detected by the second light detection unit be
Eo=|Ao·exp (−jωt+φo)|

(where Ao is an amplitude of the first reference beam and φo is a phase difference),
the determination unit determines whether ∫Ar²+Ao²+2·Ar·Ao·cos (φr−φo)Δt reaches to the reference value.

11. The hologram apparatus of claims 5, wherein
let the light intensity of the first data beam detected by the first light detection unit be
Er=|Ar·exp (−jωt+φr)|

(where Ar is amplitude of the first data beam, jωt is an angular velocity, and φr is a phase difference) and
let the light intensity of the first reference beam detected by the second light detection unit be
Eo=|Ao·exp (−jωt+φo)|

(where Ao is amplitude of the first reference beam and φo is a phase difference),
the determination unit determines whether ∫Ar·AoΔt reaches to the reference value.

12. A recording method for a hologram apparatus configured to apply a coherent data beam corresponding to data to be recorded and a coherent reference beam to a hologram recording medium to record the data in the form of a hologram in the hologram recording medium, the recording method comprising:
detecting a light intensity of at least one of the data beam and the reference beam;
determining whether light intensities of the data beam and the reference beam reach to a reference value which can form a hologram having certain diffraction efficiency, based on the detected light intensity; and
blocking application of at least one of the data beam and the reference beam into the hologram recording medium when the light intensities of the data beam and the reference beam have reached to the reference value.
